(19) United States
(12) Patent Application Publication
(10) Pub. No.: US 2023/0313350 A1
(43) Pub. Date: Oct. 5, 2023

(54) STEEL MATERIAL FOR ADDITIVE MANUFACTURING AND METHOD FOR PRODUCING IRON ALLOY

(71) Applicant: HONDA MOTOR CO., LTD., Tokyo (JP)

(72) Inventors: Masaki SHINKAWA, Saitama (JP); Kazuo KIKAWA, Saitama (JP)

(73) Assignee: HONDA MOTOR CO., LTD., Tokyo (JP)

(21) Appl. No.: 18/124,260

(22) Filed: Mar. 21, 2023

(30) Foreign Application Priority Data
Mar. 31, 2022 (JP) 2022-060234

(51) Int. Cl. C22C 38/24; B22F 10/28; B22F 10/64; C22C 38/22; C22C 38/04; C21D 6/00; B33Y 10/00; B33Y 40/20; B33Y 70/00

(52) U.S. Cl. CPC C22C 38/24; B22F 10/28; B22F 10/64; C22C 38/22; C22C 38/04; C21D 6/002; C21D 6/005; B33Y 10/00; B33Y 40/20; B33Y 70/00; B22F 2301/35; C21D 2211/002; C21D 2211/008

(57) ABSTRACT

A steel material for additive manufacturing containing: 0.3 to 0.8 mass % of C; 0.6 to 2 mass % of Mn; 1 to 7 mass % of Cr; 2 mass % or less of V; and 3 mass % or less of Mo, in which a martensite transformation start temperature is 130° C. to 200° C., and a bainite transformation start time at the martensite transformation start temperature+30° C. in an isothermal transformation curve is 200 seconds or longer.

### CROSS-REFERENCE TO RELATED APPLICATION

This application is based on and claims priority under 35 USC 119 from Japanese Patent Application No. 2022-060234 filed on Mar. 31, 2022.

### TECHNICAL FIELD

The present invention relates to a steel material for additive manufacturing and a method for producing an iron alloy.

### BACKGROUND ART

In recent years, attention has been paid to a method for producing an iron alloy manufactured article by a metal additive manufacturing method using a steel material.

For example, JP2021-195578A describes a method for producing an iron alloy, in which during a manufacturing step, a temperature of a manufactured iron alloy layer from a surface layer to a predetermined number of laminated layers of the iron alloy layer and a temperature of a base are each controlled within a specific range.

### SUMMARY OF INVENTION

In additive manufacturing of a steel material, when the amount of C increases, cracks tend to occur during the manufacturing. This is because repeated martensite transformation and austenite transformation may cause cracks due to a volume change. The repeated martensite transformation and austenite transformation refers to that a portion that is locally melted by a laser beam or an electron beam transforms into martensite by rapid cooling, then transforms into austenite again due to the heat received when a peripheral portion melts locally, and then transforms into martensite by rapid cooling.

In JP2021-195578A, during the manufacturing step. the temperature of the iron alloy layer from the surface layer to the predetermined number of laminated layers of the iron alloy layer and the temperature of the base are controlled to prevent the occurrence of distortion and cracking, but it has not been studied from the viewpoint of a strength and a toughness, and there is room for improvement.

Maraging steel is also known as an additive manufacturing material having a strength of 1500 MPa or more. However, since the maraging steel contains a large amount of rare elements such as Co, Ni, and Mo, there are problems of high cost and high risk of resource depletion.

The present invention provides a steel material for additive manufacturing from which an iron alloy that prevents occurrence of cracks and has an excellent strength and toughness can be obtained, and a method for producing an iron alloy using the steel material for additive manufacturing.

A steel material for additive manufacturing according to the present invention contains:
in terms of mass %,
C: 0.3% to 0.8%;
Mn: 0.6% to 2%;
Cr: 1% to 7%;
V: 2% or less; and
Mo: 3% or less, in which
a martensite transformation start temperature is 130° C. to 200° C., and
a bainite transformation start time at the martensite transformation start temperature +30° C. in an isothermal transformation curve is 200 seconds or longer.

According to the present invention, it is possible to provide a steel material for additive manufacturing from which an iron alloy that prevents occurrence of cracks and has an excellent strength and toughness can be obtained, and a method for producing an iron alloy using the steel material for additive manufacturing.

### BRIEF DESCRIPTION OF DRAWINGS

FIG. 1 is a schematic diagram showing an example of a manufactured object during manufacturing by an additive manufacturing method.

FIG. 2 is a schematic diagram showing an example of the manufactured object during the manufacturing by the additive manufacturing method.

FIG. 3 is a graph showing a relationship between the number of laminated layers of the manufactured object during the additive manufacturing and a temperature at a point P on the manufactured object.

FIG. 4 is a graph showing a relationship between a time and a temperature after a maximum value of the temperature at the point P on the manufactured object during the additive manufacturing is lower than an austenite transformation temperature, and showing an isothermal transformation curve.

### DETAILED DESCRIPTION OF THE INVENTION

Hereinafter, embodiments for carrying out the present invention will be described in detail.

### [Steel Material for Additive Manufacturing]

A steel material for additive manufacturing according to the present invention is an steel material for additive manufacturing containing, in terms of mass %, C: 0.3% to 0.8%, Mn: 0.6% to 2%, Cr: 1% to 7%, V: 2% or less, and Mo: 3% or less, in which a martensite transformation start temperature is 130° C. to 200° C., and a bainite transformation start time at the martensite transformation start temperature+30° C. in an isothermal transformation curve is 200 seconds or longer.

With the steel material for additive manufacturing according to the present invention, it is possible to obtain an iron alloy (manufactured object) that prevents occurrence of cracks and has an excellent strength and toughness.

First, in the additive manufacturing using the steel material for additive manufacturing according to the present invention (hereinafter also referred to as a “manufacturing material”), how a temperature at a portion of interest in a manufactured object during the manufacturing changes will be described.

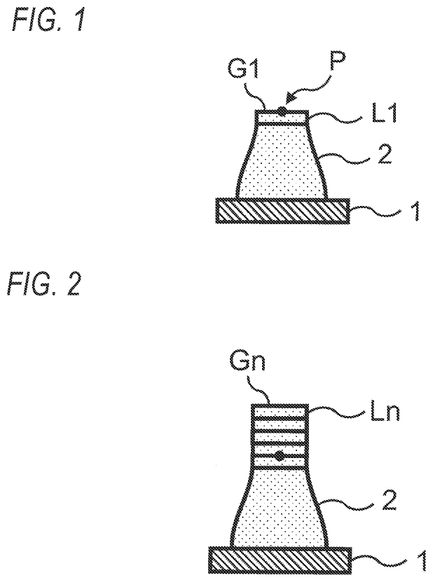

As an example, the temperature at a point P shown in FIG. 1 will be described. FIG. 1 is a schematic diagram showing a state in the middle of additive manufacturing by using a powder bed fusion method. In the powder bed fusion method, typically, as shown in FIG. 1, a powdery manufacturing material is supplied to a base plate 1 from a feed bed (not shown), and the manufacturing material is sintered by irradiation with a laser beam (or an electron beam, the same applies below) (not shown) for manufacturing. In FIG. 1, a layer L1 is laminated on a manufactured object 2 during manufacturing. The point P is any point on a manufacturing surface G1. Note that the base plate 1 is a part in an additive manufacturing machine and serves as a base of the manufactured object 2. A temperature of the base plate 1 can be controlled by a base heater (not shown) or the like. The manufacturing surface is a surface to be irradiated with the laser beam.

The number of laminated layers in the state shown in FIG. 1 is 1, and more layers are to be laminated on the laver L1.

FIG. 2 shows, as the manufacturing progresses, a state where n layers (layers L1 to Ln) are laminated (the number of laminated layers: n). In FIG. 2, a manufacturing surface of layer Ln is referred to as a manufacturing surface Gn.

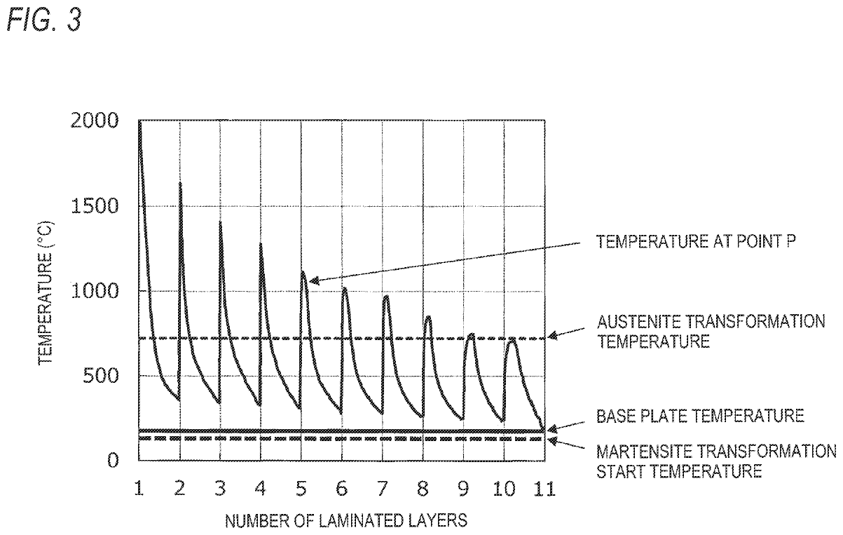

FIG. 3 shows how the temperature at the point P changes with the number of laminated layers when additive manufacturing is performed from the state shown in FIG. 1 to the state shown in FIG. 2 (for example, the case of n=10 is shown).

FIG. 3 is a graph showing a relationship between the number of laminated layers and the temperature when using a manufacturing material having a chemical composition in Example 1, which will be described later.

In FIG. 3, the horizontal axis is the number of laminated layers, and the vertical axis is the temperature at the point P.

FIG. 3 shows that, in the case of the number of laminated layers being 1, a laser beam is emitted to the position of the point P on the manufacturing material, the temperature at the point P rises to 2000° C. or higher, and the manufacturing material is melted by the laser beam. Thereafter, since the irradiation position of the laser beam moves away from the point P, it can be seen that the temperature at the point P drops rapidly.

In the case of the number of laminated layers being 2, the temperature is shown to change when the manufacturing material (powder) is spread on the layer L1 to manufacture the layer L2. When the vicinity of the point P is irradiated with a laser beam, the temperature at the point P rises rapidly and then drops rapidly. Thereafter, the same situation occurs up to the number of laminated layers being 10.

### (Martensite Transformation Start Temperature)

In the steel material for additive manufacturing according to the present invention, the martensite transformation start temperature is 130° C. to 200° C.

In a metal additive manufacturing method, generally, a region from a manufacturing surface of a manufactured object to several tens of layers toward a base plate undergoes rapid heating and rapid cooling between a temperature higher than the martensite transformation start temperature and a temperature of the base plate (base plate temperature) every time laser irradiation is performed (see FIG. 3).

If the base plate temperature is set higher than the martensite transformation start temperature. martensite transformation can be avoided, so that the risk of cracks can be reduced. Here, when the martensite transformation start temperature is high, the manufactured object is softened by the heat of the base plate held at a higher temperature, so that the martensite transformation start temperature is preferably lower. On the other hand, when an amount of C added is excessively increased in order to lower the martensite transformation start temperature, the elongation becomes extremely small.

Therefore, in the present invention, the martensite transformation start temperature of the steel material for additive manufacturing is set to 130° C. to 200° C.

In the steel material for additive manufacturing according to the present invention, the martensite transformation start temperature is preferably 150° C. to 200° C., and more preferably 170° C. to 195° C.

FIG. 3 shows the martensite transformation start temperature of the manufacturing material in Example 1 and the base plate temperature.

### (Bainite Transformation Start Time)

In the steel material for additive manufacturing according to the present invention, the bainite transformation start time at the martensite transformation start temperature+30° C. in an isothermal transformation curve (hereinafter, simply referred to as a “bainite transformation start time”) is 200 seconds or longer.

As described above, even when martensite transformation is avoided by setting the martensite transformation start temperature of the steel material for additive manufacturing to 130° C. to 200° C., when the base plate temperature is maintained for a long time, the steel material for additive manufacturing transforms into a ferrite/pearlite structure or a bainite structure. In the present invention, the structure after transformation is preferably bainite in order to obtain an iron alloy having a high strength (preferably a tensile strength of 1500 MPa or more).

In addition, in order to reduce the number of times of the bainite transformation as much as possible for the purpose of reducing a strain caused by phase transformation, a time until the bainite transformation starts is set longer than a time until the next layer starts to be manufactured in the additive manufacturing. The time until the next layer starts to be manufactured varies depending on a size of the manufactured object and performance of the additive manufacturing machine, and is usually 180 seconds or shorter, so that it is sufficient that the transformation does not start within at least 200 seconds.

Therefore, in the present invention, the bainite transformation start time of the steel material for additive manufacturing at the martensite transformation start temperature+30° C. in the isothermal transformation curve is set to 200 seconds or longer.

In the steel material for additive manufacturing according to the present invention, the bainite transformation start time is preferably 500 seconds or longer, and more preferably 800 seconds or longer.

Note that in the additive manufacturing, a cooling rate is very high and can be regarded as isothermal transformation at the base plate temperature.

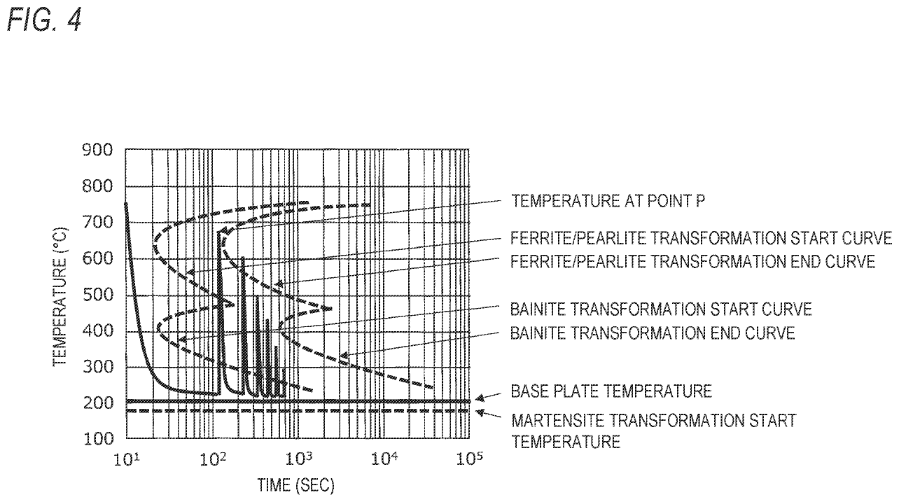

FIG. 4 shows a relationship between a time and a temperature after a maximum value of the temperature at the point P in Example 1 is lower than an austenite transformation temperature. In FIG. 4, an isothermal transformation curve of the manufacturing material in Example 1 is indicated by a dotted line.

As shown in FIG. 4, since in the steel material for additive manufacturing in Example 1, the bainite transformation start time at the martensite transformation start temperature+30° C. in the isothermal transformation curve is 200 seconds or longer, the bainite transformation does not occur in a time between the manufacturing of one layer and the manufacturing of the next layer, which reduces a strain caused by phase transformation.

### (Chemical Composition)

The steel material for additive manufacturing according to the present invention contains, in terms of mass %, C: 0.3% to 0.8%, Mn: 0.6% to 2%, Cr: 1% to 7%, V: 2% or less, and Mo: 3% or less.

Note that unless otherwise specified, the content of each alloying element is a mass-based value based on 100% of the entire steel material for additive manufacturing.

It is preferable that the steel material for additive manufacturing according to the present invention contains:
in terms of mass %,
C: 0.3% to 0.8%;
Mn: 0.6% to 2%;
Cr: 1% to 7%;
V: 2% or less;
Mo: 3% or less;
Ti: 1% or less; and
Ni: 5% or less, with the balance being Fe and inevitable impurities.

With the steel material for additive manufacturing having the above chemical composition, the toughness can be further improved.

The steel material for additive manufacturing according to the present invention contains 0.3% to 0.8% of C in terms of mass %.

C is an element that can increase the strength of the steel material. As the amount of C added increases, a martensite transformation temperature is lowered. In order to set the martensite transformation start temperature to 200° C. or lower, the amount of C added is set to 0.3% or more. On the other hand, when the amount of C added is more than 0.8%, a sufficient elongation cannot be obtained even when a bainite structure is obtained, so that the amount of C added is set to 0.8% or less.

The content of C in the steel material for additive manufacturing is preferably 0.3% to 0.5%, and more preferably 0.35% to 0.45%.

The steel material for additive manufacturing according to the present invention contains 0.6% to 2% of Mn and 1% to 7% of Cr in terms of mass %.

Mn and Cr have an effect of lowering the martensite transformation temperature and lengthening the bainite transformation start time. In particular, focusing on the bainite transformation start time, it is necessary to add Mn in an amount of 0.6% or more and Cr in an amount of 1% or more. On the other hand, even when Mn is added in an amount of more than 2% and Cr is added in an amount of more than 7%, a further effect of preventing a transformation strain by preventing the number of times of bainite transformation cannot be obtained, so that the amount of Mn added is set 2% or less and the amount of Cr added is set 7% or less.

The content of Mn in the steel material for additive manufacturing is preferably 1.0% to 2.0%, and more preferably 1.2% to 1.8%.

The content of Cr in the steel material for additive manufacturing is preferably 3.0% to 6.0%, and more preferably 4.5% to 5.5%.

The steel material for additive manufacturing according to the present invention contains 2% to or less of V in terms of mass %.

V improves the strength and the toughness by forming a carbonitride, and is desirable to be added. On the other hand, when V is added in an amount of more than 2%, a nitride and the like are excessively generated and the ductility is lowered, so that the amount of V added is set to 2% or less.

The content of V in the steel material for additive manufacturing is preferably 0.05% to 1.0%, more preferably 0.10% to 0.50%, and still more preferably 0.20% to 0.50%.

The steel material for additive manufacturing according to the present invention contains 3% to or less of Mo in terms of mass %.

Mo improves the strength and the toughness by forming a carbide, and is desirable to be added. On the other hand, even when Mo is added in excess of the existing amount of carbon capable of forming a carbide, no effect can be obtained, so that the amount added is set to 3% or less.

The content of Mo in the steel material for additive manufacturing is preferably 2% or less, more preferably 1% or less, and still more preferably 0.3% to 0.8%.

The steel material for additive manufacturing according to the present invention may contain 1% to or less of Ti in terms of mass %.

When Ti is added, a carbide can be formed to improve the strength and the toughness. On the other hand, even when Ti is added in excess of the existing amount of carbon capable of forming a carbide, no effect can be obtained, so that it is preferable that the amount added is set to 1% or less.

The steel material for additive manufacturing according to the present invention may contain 5% to or less of Ni in terms of mass %.

When Ni is added, the toughness can be improved. On the other hand, even when Ni is added in an amount of more than 5%, the effect is saturated, so that it is preferable that the amount added is set to 5% or less.

The steel material for additive manufacturing according to the present invention preferably has the balance being Fe and inevitable impurities in the above chemical composition.

In the steel material for additive manufacturing according to the present invention, a content of Fe is preferably 70 mass % or more, more preferably 80 mass % or more, and still more preferably 90 mass % or more.

The inevitable impurities are components that can be inevitably mixed from the raw materials or the environment when producing the steel material for additive manufacturing. and examples thereof include P, S, and Cu. Usually, a content of P or S is 0.1 mass % or less, and a content of Cu is 0.5 mass % or less.

The form of the steel material for additive manufacturing according to the present invention is not particularly limited, and it is preferably powdery or sheet-like, and more preferably powdery. When the steel material for additive manufacturing is powdery, it can be used in additive manufacturing by using a powder bed fusion method.

When the steel material for additive manufacturing according to the present invention is powdery. the particle size is not particularly limited. Known particle sizes suitable for additive manufacturing (preferably for manufacturing using a 3D printer) (for example, 30 μm to 60 μm of volume average particle size (D₅₀) measured with a laser diffraction particle size distribution measuring device) can be used.

A method for producing the steel material for additive manufacturing according to the present invention is not particularly limited, and a known method can be used.

When the steel material for additive manufacturing according to the present invention is powdery, the steel material for additive manufacturing can be produced by using a known method (for example, a gas atomization method, a water atomization method, a plasma atomization method, and a centrifugal atomization method).

### [Method for Producing Iron Alloy]

A method for producing an iron alloy according to the present invention is a method for producing an iron alloy by producing an iron alloy by using a metal additive manufacturing method, the method including:
laminating and manufacturing an iron alloy layer on a base plate by irradiating the steel material for additive manufacturing according to the present invention with at least one of a laser beam and an electron beam and melting the steel material for additive manufacturing, in which
manufacturing is performed in a state where at least a temperature in a region within 1 mm from a manufacturing surface toward the base plate is increased to and maintained at the martensite transformation start temperature or higher.

According to the method for producing an iron alloy of the present invention, it is possible to obtain an iron alloy (manufactured object) that prevents the occurrence of cracks and has an excellent strength and toughness.

Since, in the method for producing an iron alloy according to the present invention, the manufacturing is performed in the state where at least the temperature in the region within 1 mm from the manufacturing surface toward the base plate is increased to and maintained at the martensite transformation start temperature or higher, the martensite transformation can be avoided, and thus the risk of cracks in the iron alloy can be reduced. A method of increasing and maintaining the temperature in the region within 1 mm from the manufacturing surface toward the base plate at the martensite transformation start temperature or higher is not particularly limited. Examples thereof include a method of controlling the base plate temperature to the martensite transformation start temperature or higher by using a base heater or the like, and a method of controlling the temperature in the region within 1 mm from the manufacturing surface toward the base plate to the martensite transformation start temperature or higher by using an infrared heater or the like.

### (Base Plate Temperature)

In the method for producing an iron alloy according to the present invention, the base plate temperature is preferably higher than the martensite transformation temperature. Accordingly, the martensite transformation of the iron alloy can be avoided.

Even when the martensite transformation is avoided, the iron alloy transforms into a ferrite/pearlite structure or a bainite structure if it is maintained at the base plate temperature for a long time. In the present invention, the structure after transformation is preferably bainite in order to obtain an iron alloy having a high strength (preferably a tensile strength of 1500 MPa or more). Therefore, the base plate temperature is preferably set to a temperature higher than the martensite transformation temperature by 0° C. to 50° C., more preferably set to a temperature higher than the martensite transformation temperature by 5° C. to 30° C., and still more preferably set to a temperature higher than the martensite transformation temperature by 10° C. to 30° C.

The metal additive manufacturing method in the method for producing an iron alloy according to the present invention is preferably a metal additive manufacturing method using a powdery manufacturing material, and more preferably a manufacturing method using a 3D printer.

As the 3D printer, a known one can be used.

The additive manufacturing method is not particularly limited, and for example, a powder bed fusion method and a direct energy deposition method are preferred, and a powder bed fusion method is particularly preferred.

The iron alloy (manufactured object) produced by the production method according to the present invention prevents occurrence of cracks and has an excellent strength and toughness (preferably a tensile strength of 1500 MPa or more and an elongation of 7% or more), and can thus be applied to various structural members such as automobile parts. In particular, high effects can be exhibited when applied to lightweight members that take advantage of a high degree of freedom in shape that is a feature of additive manufacturing. It can also be applied to a mold having a cooling circuit therein.

### EXAMPLES

Hereinafter, the present invention will be described more specifically by way of Examples and Comparative Examples, but the present invention is not limited thereto.

A powder (average particle size: 45 μm) was prepared with the composition shown in Table 1 below and the balance being Fe and inevitable impurities. The powder in each of Examples and Comparative Examples was used as a steel material for additive manufacturing (manufacturing material).

The steel material for additive manufacturing in each of Examples and Comparative Examples in Table 1 was obtained by additive manufacturing using a manufacturing machine (3D printer) to produce a round bar having a diameter of 12 mm and a length of 80 mm. M290 manufactured by EOS was used as the manufacturing machine, and the manufacturing conditions included an output of 260 W, a layer thickness of 40 μm, a scan speed of 700 mm/s, a hatch distance of 0.1 mm. and a preheating temperature of 200° C. The obtained round bar was cut on the entire surface and processed into a test piece.

Table 1 shows the martensite transformation start temperature and the bainite transformation start time of the steel material for additive manufacturing in each of Examples and Comparative Examples. The martensite transformation start temperature and the bainite transformation start time were measured by a Formaster tester using a steel ingot test piece having a diameter of 3 mm and a length of 10 mm.

### <Presence or Absence of Cracks>

The obtained manufactured object was observed visually and with an optical microscope to confirm the presence or absence of cracks.

### <Measurement of Tensile Strength>

Each of steel materials for additive manufacturing shown in Table 1 was used to prepare a round bar-shaped manufactured article having a diameter of 12 mm and a length of 80 mm by using a 3D printer, and the entire surface of the round bar-shaped manufactured article was cut to prepare a test piece. A tensile test was performed at room temperature at a tensile speed of 5 mm/min using Autograph manufactured by Shimadzu Corporation.

Note that measurement of the tensile strength (MPa) was performed according to JIS Z 2241, and the test piece was a round bar test piece according to JIS No. 14A.

### <Measurement of Elongation>

The elongation at break of the above test piece was measured by measuring, with an extensometer, a change in a distance between scores during the above tensile strength measurement.

TABLE 1

| | | | | | | Martensite |
|---|---|---|---|---|---|---|
| | | | | | | transformation |
| | | | | | | start |
| | C | Mn | Cr | V | Mo | temperature |
| | (mass %) | (mass %) | (mass %) | (mass %) | (mass %) | (° C.) |
| Example 1 | 0.55 | 1.8 | 5.0 | 0.15 | 0 | 189 |
| Example 2 | 0.56 | 1.9 | 5.8 | 0.15 | 0 | 172 |
| Example 3 | 0.70 | 1.2 | 2.0 | 0.30 | 0 | 180 |
| Example 4 | 0.56 | 1.3 | 5.2 | 0.12 | 0.5 | 194 |
| Comparative | 0.45 | 1.2 | 1.0 | 0.15 | 0 | 298 |
| Example 1 | | | | | | |
| Comparative | 0.70 | 0.6 | 0.1 | 0.14 | 0 | 221 |
| Example 2 | | | | | | |
| Comparative | 0.85 | 1.2 | 3.0 | 0.15 | 0 | 104 |
| Example 3 | | | | | | |

| | Bainite | Base plate | Presence or | Tensile | |
|---|---|---|---|---|---|
| | transformation | temperature | Absence of | strength | Elongation |
| | start time (s) | (° C.) | Crack | (MPa) | (%) |
| Example 1 | 1000 | 200 | Absence | 1630 | 7.1 |
| Example 2 | 1500 | 200 | Absence | 1560 | 9.3 |
| Example 3 | 800 | 180 | Absence | 2238 | 7.2 |
| Example 4 | 1000 | 200 | Absence | 1635 | 10.2 |
| Comparative | 30 | 200 | Presence | Unmeasurable | — |
| Example 1 | | | | | |
| Comparative | 60 | 200 | Absence | Unmeasurable | <0.2 |
| Example 2 | | | | | |
| Comparative | 200 | 150 | Absence | Unmeasurable | <0.2 |
| Example 3 | | | | | |

As can be seen from Table 1 that with the steel materials for additive manufacturing in Examples 1 to 4, it is possible to produce a manufactured object having no cracks, and having a tensile strength of 1500 MPa or more and an elongation of 7% or more.

Example 1 is for representative components. FIG. 3 and FIG. 4 show a temperature change in additive manufacturing using the manufacturing material in Example 1. As shown in FIG. 3, by setting the base plate temperature to 200° C., which is higher than the martensite transformation start temperature, the sample in Example 1 is stably subjected to manufacturing without cracks. In addition, when the manufacturing progresses and the maximum value of the temperature is lower than the austenite transformation temperature, as shown in FIG. 4, the temperature changes between a temperature range in which the austenite structure remains unchanged, a temperature range in which the transformation to the bainite structure progresses, and a temperature range in which the transformation to the ferrite/pearlite structure progresses, and the structure after the manufacturing is a mixed structure of bainite and residual austenite. Therefore, a high elongation is obtained in spite of a high strength.

Example 2 is an example in which the amounts of Mn and Cr added are increased with respect to Example 1, and a large elongation is obtained.

Example 3 is an example in which the amount of C added is increased, and a large tensile strength is obtained.

Example 4 is an example in which Mo is positively added, and a large elongation is obtained.

Comparative Example 1 is an example in which the martensite transformation start temperature is higher than 200° C. and the base plate temperature is lower than the martensite transformation start temperature. The tensile test cannot be performed because cracks occur during the manufacturing.

Comparative Example 2 is an example in which the bainite transformation start time is shorter than 200 seconds. Note that although the martensite transformation start temperature is slightly higher than 200° C., no cracks occur. When this sample is subjected to a tensile test, the strength cannot be measured because it is broken at a very low elongation.

Comparative Example 3 is an example in which the amount of C added is too large. When this sample is subjected to a tensile test, the strength cannot be measured because it is broken at a very low elongation.

Although the embodiment of the present invention has been described above, the present invention is not limited to the above embodiment, and modifications, improvements, and the like can be made as appropriate.

In the present description, at least the following matters are described.
(1) A steel material for additive manufacturing containing:
in terms of mass %,
C: 0.3% to 0.8%;
Mn: 0.6% to 2%;
Cr: 1% to 7%;
V: 2% or less; and
Mo: 3% or less, in which
a martensite transformation start temperature is 130° C. to 200° C., and
a bainite transformation start time at the martensite transformation start temperature +30° C. in an isothermal transformation curve is 200 seconds or longer.

According to (1), it is possible to obtain an iron alloy that prevents the occurrence of cracks and has an excellent strength and toughness.
(2) The steel material for additive manufacturing according to (1) containing:
in terms of mass %,
C: 0.3% to 0.8%;
Mn: 0.6% to 2%;
Cr: 1% to 7%;
V: 2% or less;
Mo: 3% or less;
Ti: 1% or less; and
Ni: 5% or less, with the balance being Fe and inevitable impurities.

According to (2), the toughness can be further improved.
(3) The steel material additive manufacturing according to (1) or (2), which is powdery.

According to (3), additive manufacturing can be performed by using a powder bed fusion method.
(4) A method for producing an iron alloy by producing an iron alloy by using a metal additive manufacturing method, the method including:
laminating and manufacturing an iron alloy layer on a base plate by irradiating the steel material for additive manufacturing according to any one of (1) to (3) with at least one of a laser beam and an electron beam and melting the steel material for additive manufacturing, in which
manufacturing is performed in a state where at least a temperature in a region within 1 mm from a manufacturing surface toward the base plate is increased to and maintained at the martensite transformation start temperature or higher.

According to (4). it is possible to obtain an iron alloy that prevents the occurrence of cracks and has an excellent strength and toughness.

What is claimed is:

1. A steel material for additive manufacturing comprising:
0.3 to 0.8 mass % of C;
0.6 to 2 mass % of Mn;
1 to 7 mass % of Cr;
2 mass % or less of V; and
3 mass % or less of Mo, wherein
a martensite transformation start temperature is 130° C. to 200° C., and
a bainite transformation start time at the martensite transformation start temperature +30° C. in an isothermal transformation curve is 200 seconds or longer.

2. The steel material for additive manufacturing according to claim 1 comprising:
0.3 to 0.8 mass % of C;
0.6 to 2 mass % of Mn;
1 to 7 mass % of Cr;
2 mass % or less of V;
3 mass % or less of Mo;
1 mass % or less of Ti; and
5 mass % or less of Ni, wherein
a balance of the steel material for additive manufacturing Fe and inevitable impurities.

3. The steel material for additive manufacturing according to claim 1, wherein the steel material for additive manufacturing is powdery.

4. The steel material for additive manufacturing according to claim 2, wherein the steel material for additive manufacturing is powdery.

5. A method for producing an iron alloy by using a metal additive manufacturing method, the method comprising:
manufacturing an iron alloy layer while laminating the iron alloy layer on a base plate by irradiating the steel material for additive manufacturing according to claim 1 with at least one of a laser beam and an electron beam and melting the steel material for additive manufacturing, wherein
manufacturing is performed in a state where at least a temperature in a region within 1 mm from a manufacturing surface toward the base plate is increased to and maintained at a martensite transformation start temperature or higher.

6. A method for producing an iron alloy by using a metal additive manufacturing method, the method comprising:
manufacturing an iron alloy layer while laminating the iron alloy layer on a base plate by irradiating the steel material for additive manufacturing according to claim 2 with at least one of a laser beam and an electron beam and melting the steel material for additive manufacturing, wherein
manufacturing is performed in a state where at least a temperature in a region within 1 mm from a manufacturing surface toward the base plate is increased to and maintained at a martensite transformation start temperature or higher.

7. A method for producing an iron alloy by using a metal additive manufacturing method, the method comprising:
manufacturing an iron alloy layer while laminating the iron alloy layer on a base plate by irradiating the steel material for additive manufacturing according to claim 3 with at least one of a laser beam and an electron beam and melting the steel material for additive manufacturing, wherein
manufacturing is performed in a state where at least a temperature in a region within 1 mm from a manufacturing surface toward the base plate is increased to and maintained at a martensite transformation start temperature or higher.

8. A method for producing an iron alloy by using a metal additive manufacturing method, the method comprising:
manufacturing an iron alloy layer while laminating the iron alloy layer on a base plate by irradiating the steel material for additive manufacturing according to claim 4 with at least one of a laser beam and an electron beam and melting the steel material for additive manufacturing, wherein
manufacturing is performed in a state where at least a temperature in a region within 1 mm from a manufacturing surface toward the base plate is increased to and maintained at a martensite transformation start temperature or higher.
